(19) United States
(12) Patent Application Publication
(10) Pub. No.: US 2011/0035033 A1
(43) Pub. Date: Feb. 10, 2011

(54) REAL-TIME CUSTOMIZATION OF AUDIO STREAMS

(75) Inventor: Norman Friedenberger, Berlin (DE)

Correspondence Address: Cantor Colburn LLP - Fox Entertainment Group, 20 Church Street, 22nd Floor, Hartford, CT, 06103, US

(73) Assignee: FOX MOBILE DICTRIBUTION, LLC., Beverly Hills, CA (US)

(21) Appl. No.: 12/851,068

(22) Filed: Aug. 5, 2010

Related U.S. Application Data
(60) Provisional application No. 61/231,423, filed on Aug. 5, 2009.

(51) Int. Cl. G06F 17/00; G06F 3/01

(52) U.S. Cl. 700/94; 715/716

(57) ABSTRACT

A method of real-time customization of an audio stream includes retrieving a set of parameters related to a current state of a device, determining a pattern, tempo, background loop, pitch, and number of foreground notes for the audio stream based upon the set of parameters, and creating an audio stream based upon the determination.

### CROSS REFERENCE TO RELATED APPLICATIONS

This application claims priority under 35 U.S.C. §119 to Provisional Patent Application Ser. No. 61/231,423, filed Aug. 5, 2009, entitled “MOBILE MOOD MACHINE,” the entire contents of which are hereby incorporated by reference herein.

### TECHNICAL FIELD

The present invention is generally related to audio-based computer technologies. More particularly, example embodiments of the present invention are related to methods of providing a customized audio-stream through intelligent comparison of environmental factors.

### BACKGROUND OF THE INVENTION

Conventionally, audio-streams and audio-stream technology depends upon existing audio data files stored on a computer. These audio data files are played back using a computer apparatus individually, for example, as a single stream of music. Mixing or blending of several audio files may be accomplished, however, the mixing or blending is conventionally performed by a user picking and choosing to produce a desired effect. Generally, the user is skilled in audio-mixing. It follows that individuals not skilled in audio-mixing may have difficulty in producing desired, blended audio streams.

### SUMMARY OF THE INVENTION

According to an example embodiment of the present invention, a method of real-time customization of an audio stream includes retrieving a set of parameters related to a current state of a device, determining a pattern, tempo, background loop, pitch, and number of foreground notes for the audio stream based upon the set of parameters, and creating an audio stream based upon the determination.

According to another example embodiment of the present invention, a system of real-time customization of an audio stream. The system includes a service provider, the service provider storing a plurality of information related to a state of a geographic location. The system further includes a device in communication with the service provider, the device configured and disposed to retrieve information related to a current state of the device from the service provider based on a geographic location of the device, and the device further configured and disposed to customize an audio-stream based on the retrieved information.

According to another example embodiment of the present invention, a computer-implemented user-interface rendered on a display portion of a portable computer apparatus includes a plurality of controls, each control of the plurality of controls including user-configurable and pre-existing states of the portable computer apparatus. A processor of the portable computer apparatus is configured and disposed to perform a method of real-time customization of an audio stream. The method includes retrieving a set of parameters based on user-manipulation of the user-interface and the plurality of controls, determining a pattern, tempo, background loop, pitch, and number of foreground notes for a customized audio stream based upon the set of parameters, and creating an audio stream based upon the determination.

According to another example embodiment of the present invention, a computer program product includes a computer readable medium containing computer executable code thereon; the computer executable code, when processed by a processor of a computer, directs the processor to perform a method of real-time customization of an audio stream. The method includes retrieving a set of parameters related to a current state of a device, determining a pattern, tempo, background loop, pitch, and number of foreground notes for the audio stream based upon the set of parameters, and creating an audio stream based upon the determination.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views. The figures:

FIG. 1 is an example user interface, according to an example embodiment;

FIG. 2 is an example user interface, according to an example embodiment;

FIG. 3 is an example user interface, according to an example embodiment;

FIG. 4 is an example user interface, according to an example embodiment;

FIG. 5 is an example user interface, according to an example embodiment;

FIG. 6 is an example user interface, according to an example embodiment;

FIG. 7 is an example user interface, according to an example embodiment;

FIG. 8 is an example user interface, according to an example embodiment;

FIG. 9 is an example method of real-time customization of an audio stream;

FIG. 10 is an example system, according to an example embodiment;

FIG. 11 is an example computer apparatus, according to an example embodiment; and

FIG. 12 is an example computer-usable medium, according to an example embodiment.

### DETAILED DESCRIPTION OF THE INVENTION

Further to the brief description provided above and associated textual detail of each of the figures, the following description provides additional details of example embodiments of the present invention. It should be understood, however, that there is no intent to limit example embodiments to the particular forms and particular details disclosed, but to the contrary, example embodiments are to cover all modifications, equivalents, and alternatives falling within the scope of example embodiments and claims. Like numbers refer to like elements throughout the description of the figures.

It will be understood that, although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Hereinafter, example embodiments of the present invention are described in detail.

Example embodiments of the present invention may generate a music stream (or streams) that is influenced by a plurality of parameters. These parameters may include geographical location, movement speed/velocity, time of day, weather conditions, ambient temperature, and/or any other suitable parameters.

Generally, example embodiments may include a user interface and application on a mobile device/computer apparatus, for example, to determine geographic location and velocity. Further, the application may include code-portions configured to blend/mix existing audio files into a configurable audio stream. The blend/mix audio stream may be tailored based upon the parameters.

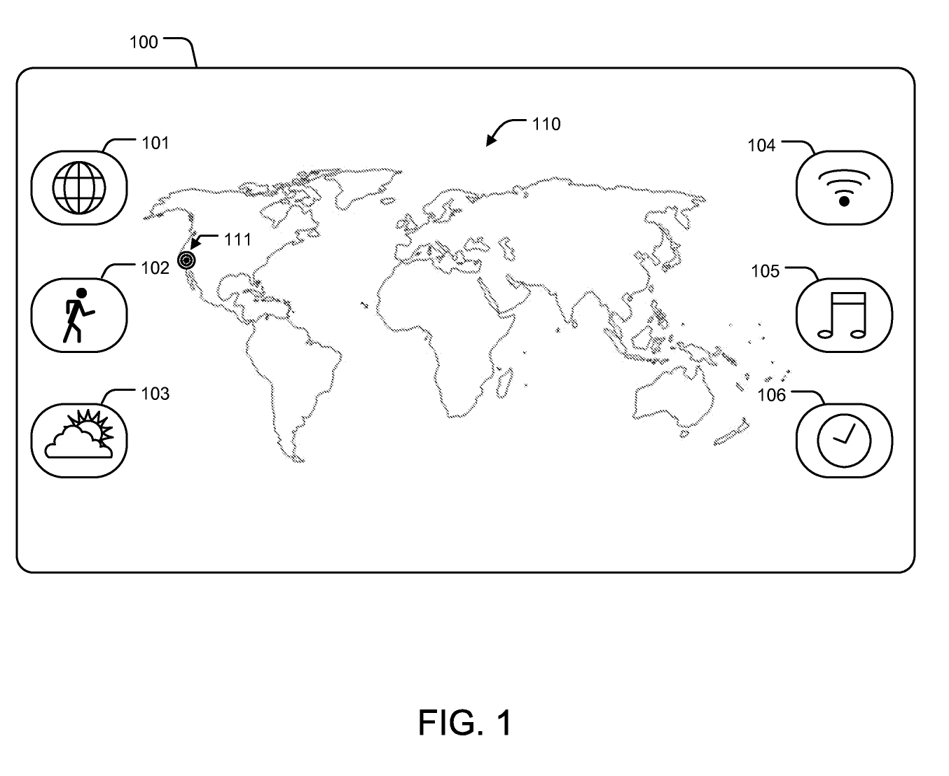

A user interface of example embodiments may include icon buttons or other graphical elements for easy manipulation by a user of a computer device (e.g., mobile device). The graphical elements may allow control or revision of desired audio-stream mixing through manipulation of the above-described parameters. FIGS. 1-8 illustrate example computer-implemented user interfaces, according to example embodiments.

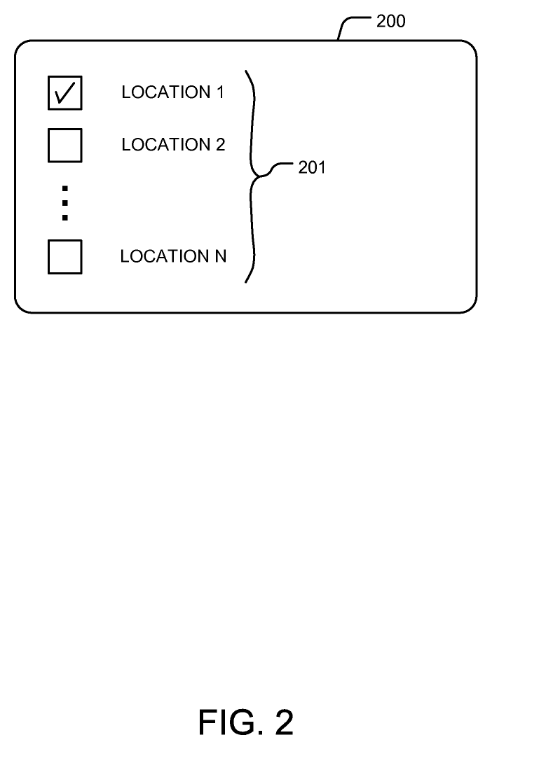

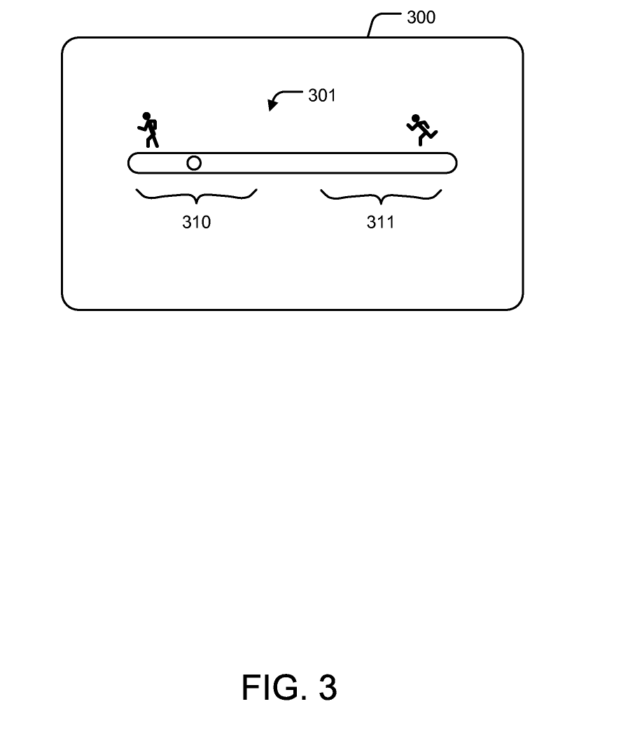

FIG. 1 is an example user interface, according to an example embodiment. As illustrated, the user interface 100 may be a general or default interface, rendered on a computer/device screen, for manipulation by a user. The interface 100 includes a plurality of renderings and user-controls. For example, the interface 100 may include a location control 101. The location control 101 may direct rendering of a location interface for selection of a plurality of parameters by a user (see FIG. 2). The interface 100 may further include speed control 102. The speed control 102 may direct rendering of a speed interface for selection of a plurality of parameters by a user (see FIG. 3). The interface 100 may further include weather control 103. The weather control 103 may direct rendering of a weather interface for selection of a plurality of parameters by a user.

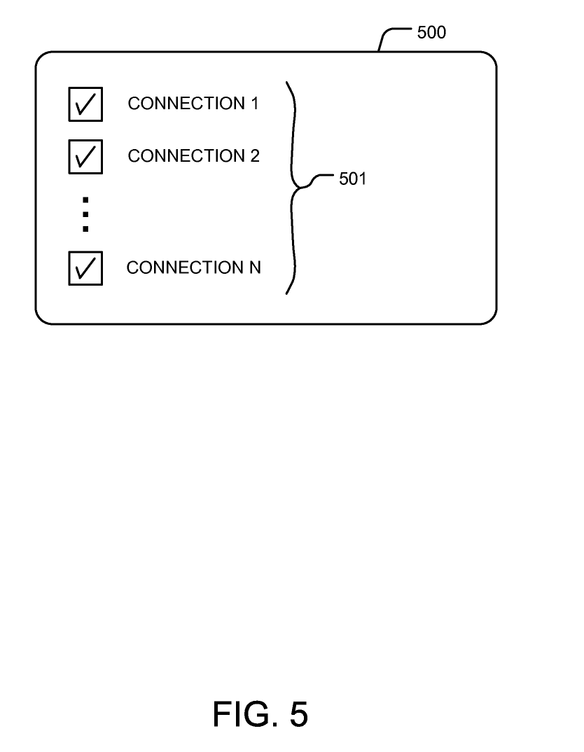

The interface 100 may further include data connection control 104. The data connection control 104 may turn on/off a default data connection of a device presenting the interface 100, or alternatively, a number of devices presenting the interface 100. In other embodiments, the data connection control 104 may direct rendering of a data connection interface for selection of a plurality of parameters by a user (see FIG. 5).

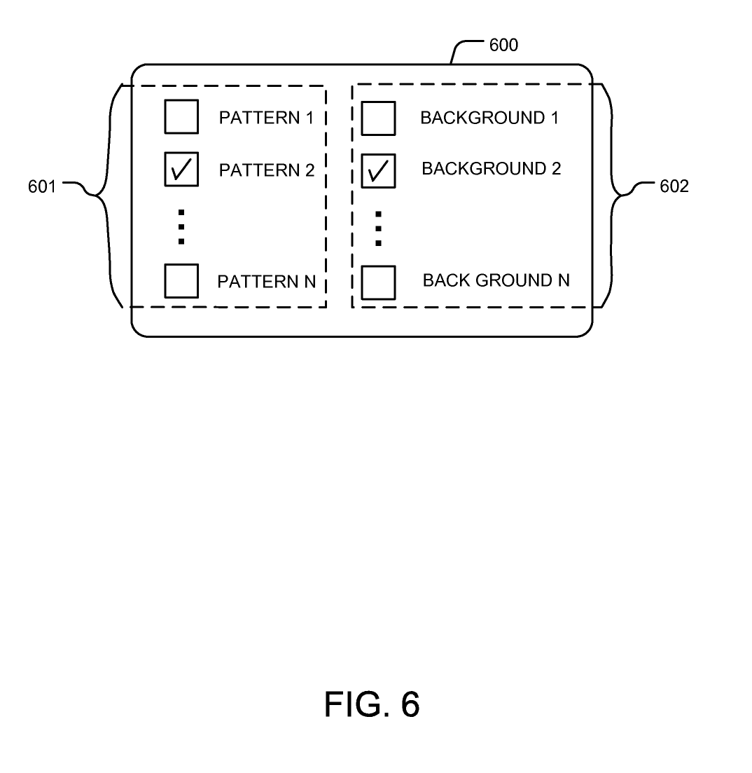

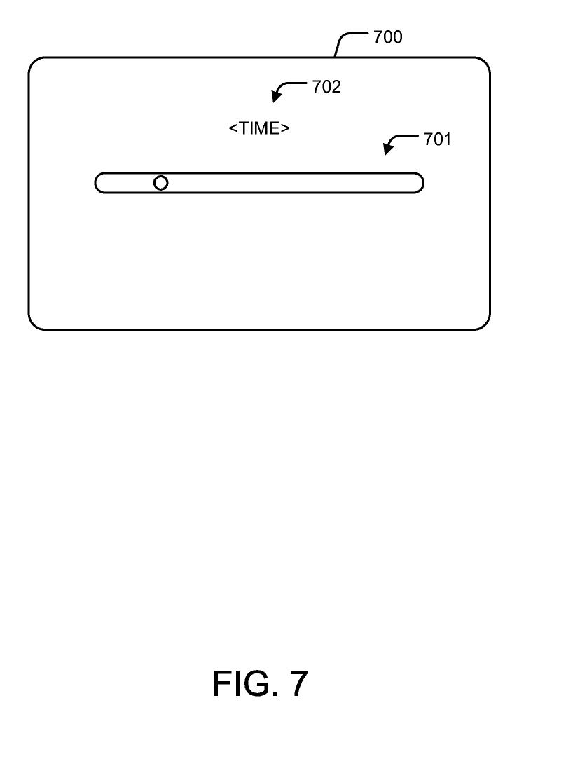

The interface 100 may further include audio stream control 105. The audio stream control 105 may direct rendering of an audio stream interface for selection of a plurality of parameters by a user (see FIG. 6). The interface 100 may further include time control 106. The time control 106 may direct rendering of a time interface for selection of a plurality of parameters by a user (see FIG. 7).

The interface 100 may further include geographical rendering 110. The geographical rendering 110 may include a plurality of elements for viewing by a user. For example, element 111 depicts a current or selected geographical location. The element 111 may be controlled through a location interface (see FIG. 2). The geographical rendering may further include elements representative of any suitable parameter or event. For example, the geographical rendering may include elements directed to weather, time zones, current time, speed, or other suitable elements. Further, although the illustrated form of geographical rendering 110 is a world map, it should be understood that example embodiments are not so limited. For example, any suitable geographical representation may be rendered. Suitable representations may include world-level, country-level, state/province-level, county/municipality-level, city level, or any suitable level of geographical representation. Furthermore, although illustrated as a generic map, the geographical rendering 110 may include any level of detail. For example, the geographical rendering 110 may include landmarks, rivers, borders, streets, satellite imagery, custom floor-plan(s) (for example, in a museum, home, or other building), or any other suitable detail. The detail may be customizable through a geographic or location interface (see FIG. 2).

Hereinafter, the several example user interfaces mentioned above are described in detail.

FIG. 2 is an example user interface 200, according to an example embodiment. The interface 200 may be a location interface. For example, the location control 101 may open or direct rendering of a graphical list 201 of geographical locations such that a user may choose a desired location or location different than a current location. Alternatively, a map or a portion of a map may be displayed for more graphical interaction in choosing a new geographic location. A chosen location (or actual GPS data, WiFi location data, or other data, if available) may be represented by a dot on the map or other suitable designation. Upon selection of a desired location, the default interface 100 may be rendered, either through additional interaction by a user in additional control elements (not illustrated), or through automatic operation after a time-delay or upon selection of the desired location.

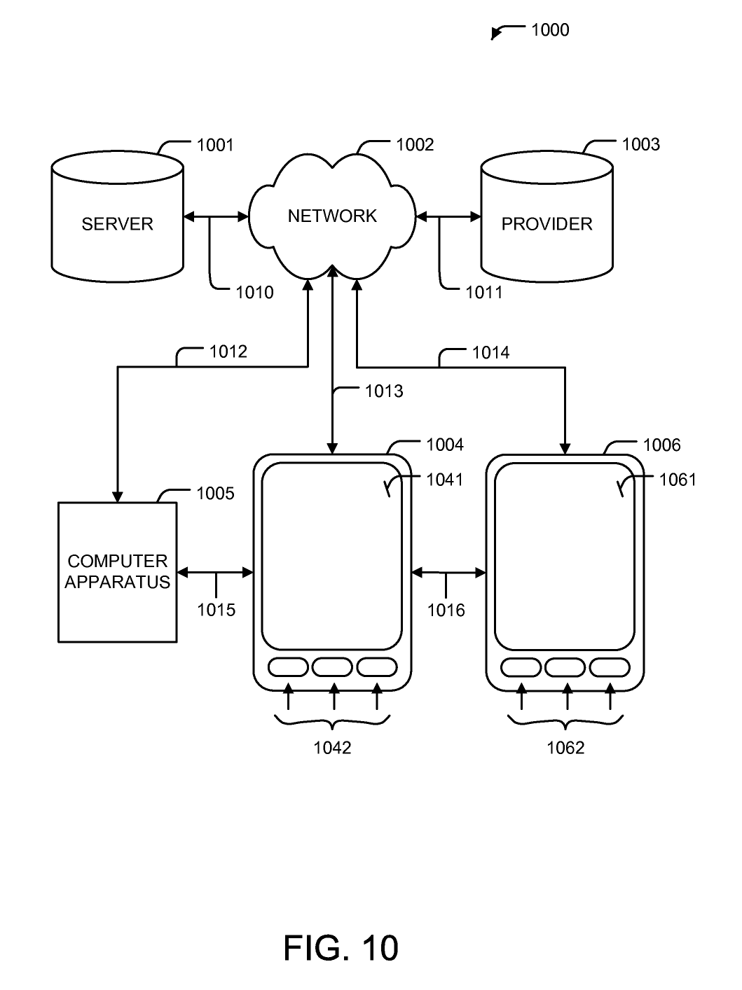

FIG. 3 is an example user interface 300, according to an example embodiment. The interface 300 may be a speed interface. For example, the speed control 102 may open or direct rendering of a graphical slider 301 to display (or override/set) the current movement speed of a device presenting the interface 300. The slider may be based on a scaling factor, or fixed speed/velocity values which may be selectable through a different user-interface portion (not illustrated). As shown, portion 310 of the slider 301 may represent slower movement speeds; and portion 311 of the slider 301 may represent faster movement speeds. The movement speed of a device may be acquired through mathematical manipulation of location information. For example, a location may be acquired through GPS data, WiFi connection data, base station data, base station cellular data, or other suitable data retrieved at a device. Previously acquired location data (including time) may be used with present location and time to deduce or determine a speed at which the device traveled from the previous location to a present location. The speed information may be averaged for a total-device-on time or a total time from which an audio stream has been produced. Alternatively, or in combination, most recent speed information may be produced. The speed information may be displayed/rendered on any interface described herein, updated periodically, and/or provided with a statistical/analytical display upon cessation of the audio-streaming methodologies described herein, or in regular intervals or upon request by a user. The statistical/analytical information may be presented as a histogram, bar graph, chart, listing, or any other suitable display arrangement. The information may be accessible to a user at any time, may be stored for future reference, or may be transmitted through a data connection (see FIG. 10).

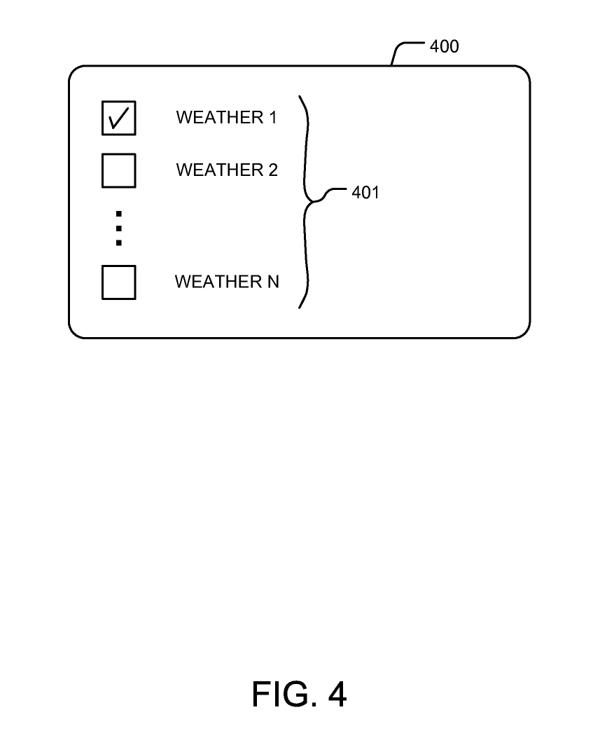

FIG. 4 is an example user interface 400, according to an example embodiment. The interface 400 may be a weather interface. For example, weather control 103 may open or direct rendering of a graphical list 401 of different weather conditions such that a user may choose a desired weather condition, for example, if different from a current weather condition. Weather conditions may include a sunny day, a partly cloudy sky, a cloudy sky, rain, snow, temperature, and/or other suitable weather conditions. Current weather conditions may be accessed through a server or service provider over any suitable data connection (see FIG. 10). The weather conditions (selected or retrieved) may be displayed/rendered on any user interface described herein. The weather conditions may be updated periodically, overridden by a user, displayed graphically, displayed textually, or presented to a user in any meaningful manner. Furthermore, weather conditions may be matched with speed information to provide meaningful information to a user on speed versus weather conditions. Such information may be presented individually, or in combination with the statistical/analytical information described above.

FIG. 5 is an example user interface 500, according to an example embodiment. The interface 500 may be a data connection interface. For example, in addition to those user-interface elements/controls described above, the online/connection interface 500 may be presented through operation of connection control 104 such that a user may choose whether audio-stream mixing may be based on constantly updated parameters, current values only, or any combination of the two. The interface 500 may include a graphical listing 501 of available parameters. The parameters may include, but are not limited to, available data connections (GPS, WiFi, Internet, Cellular Service, etc), data connection preferences (update parameters, use current values, update frequency, etc), or any other suitable parameters. For example a user may select a particular or combination of data connections to use, deactivate, or update periodically. Further, a user may select other parameters as described above for use in intelligent audio-stream mixing.

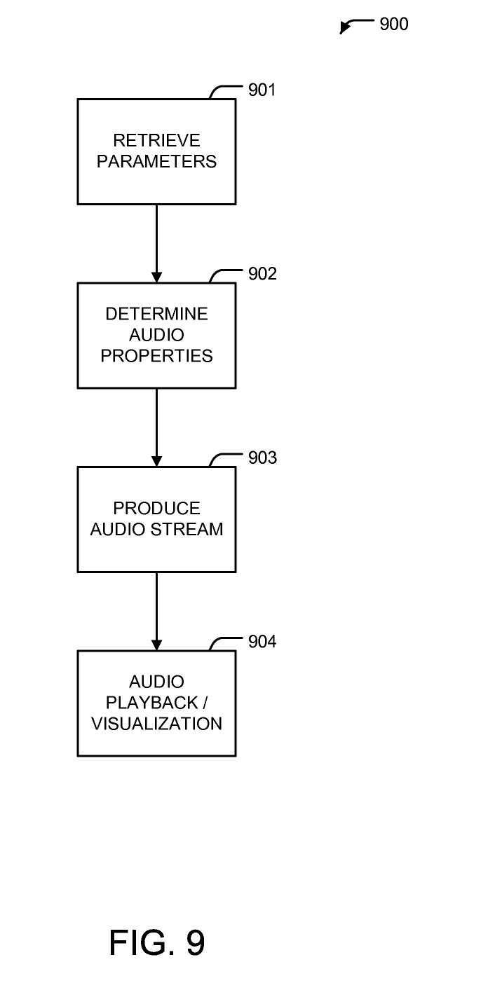

FIG. 6 is an example user interface 600, according to an example embodiment. Interface 600 may be an audio-stream interface. For example, audio-stream control 105 may open or direct rendering of interface 600. Interface 600 may provide graphical listings 601, 602 of different audio-stream mixing parameters. The parameters may include music patterns and/or background patterns. Additional parameters may include note/tone values (e.g., allows the user to choose between different patterns and background play modes), pattern values (e.g., on/off/user-mode wherein a user generates tones through manipulation of the mobile device, for example by shaking or moving the mobile device), background loop (e.g., on/off), time (e.g., display or override/set the current time), or any other suitable parameters. Using these parameters and the location, speed, weather, and/or data connection information described above, intelligent mixing of a custom audio-stream may be initiated (see FIG. 9).

FIG. 7 is an example user interface 700, according to an example embodiment. Interface 700 may be a time interface. For example, the time control 106 may open or direct rendering of a graphical slider 701 to display (or override/set) the current time elapsed (or time remaining) of an audio stream of a device presenting the interface 700.

Although described above as individual interfaces, it should be understood that any or all of the interfaces 200, 300, 400, 500, 600, and/or 700 may be rendered upon other interfaces, or may be rendered in combination with other interfaces. The particular forms described and illustrated are for the purpose of understanding of example embodiments only, and should not be construed as limiting. Furthermore, in addition to those interfaces presented and described above, it is noted that example embodiments may further provide visual display or representation of an audio stream rendered upon a user interface, including any user interface described herein.

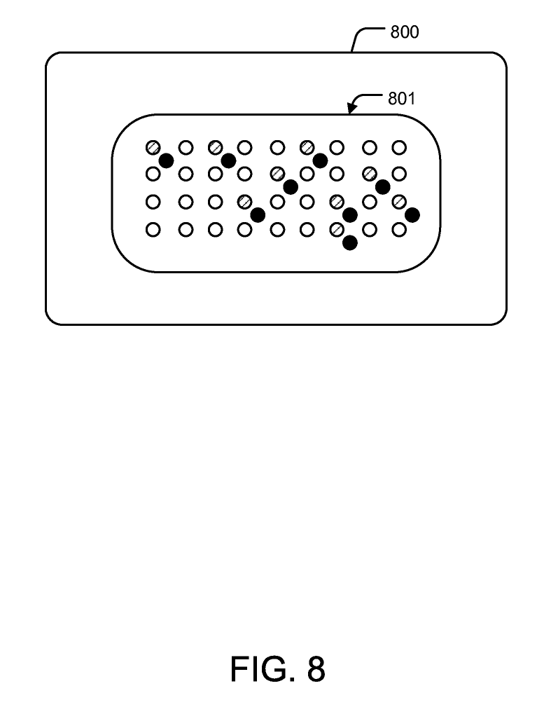

FIG. 8 is an example user interface 800, according to an example embodiment. The interface 800 may be any of the interfaces described herein, or may be an interface rendered upon composition of a custom audio-stream. The interface 800 may include a visual rendering 801 presented thereon. For example, there may be other user interface elements rendered below the rendering 801, which may be accessible through interaction with the interface 800 by a user. For example, touching the display or selecting another interface element may cease or pause rendering of the visual rendering 801 for further control of a device presenting the interface 800.

The visual rendering 801 may be a representation of the custom audio-stream of the device. A plurality of visual representations are possible, and thus example embodiments should not be limited to only the example illustrated, but should be applicable to any desired visual rendering representative of an audio stream. In the example provided, visual rendering 801 includes a plurality of dots/elements representing portions of the audio-stream. The dots/elements may move erratically for speedier compositions, or may remain fixed. The dots/elements may be colored or shaded based on parameters of the audio-stream. For example, different colors or shades representing speed/weather/location (sunny, fast, slow, beach, city, etc) may be presented dynamically at any or all of the dots/elements.

Additional user interface elements may include an audio wave animation configured to display audio information. For example, sinusoidal or linear waves may be presented. Furthermore, bar-graph-like equalizer elements or other such elements may be rendered on 801. The animated elements may be configured to allow a user to select portions of the audio wave, fast-forward, rewind, etc. Additionally, selecting the audio wave may enable a video selection screen (not illustrated). Upon selection, the current sound mix may be faded out and another background loop may be initiated. If the user wishes to return to the previous audio stream, the previous stream may be faded back in.

Within the video selection view noted above, a user may select between different video clips or possible video renderings. Touching/selecting a video thumbnail (e.g., static image) may initiate a full screen video view (or a rendering on a portion of a display or interface) according to the selected visual representation.

As described above, example embodiments provide a plurality of interfaces by which a user may select, adjust, and/or override parameters representative of a current state of a device (location, speed, weather conditions near the device, etc). Using these parameters, example embodiments may provide customization of an audio stream as described in detail below.

FIG. 9 is an example method of real-time customization of an audio stream. According to example embodiments of the present invention, the methodologies may mix a plurality of audio files in parallel. According to at least one example embodiment, the factors/elements/parameters described above may affect the audio mixing.

According to example embodiments, a method 900 includes retrieving parameters at block 901. The parameters may be retrieved by a device from a plurality of sources. For example, a device may retrieve pre-selected parameters, dynamically updated parameters, or any other suitable parameters associated with the device. The parameters may be fixed and stored on the device for a continuous audio-loop, or may be updated at any desired or predetermined frequency for dynamic changes to an audio stream. Therefore, although block 901 is presented in a flow-chart, it should be understood that block 901 and associated actions may be repeated throughout implementation of the method 900.

The method 900 further includes determining audio properties based on the retrieved parameters at block 902. For example, audio properties may be properties used to produce an audio stream. The properties may include tempo, octaves, audio ranges, background patterns, or any other suitable properties. These properties may be based on the retrieved parameters.

For example, geographic location may affect the mixing of a pattern of audio sounds. The geographic location may be retrieved automatically through a GPS chip (if one exists), or may be chosen as described above. There may be a plurality of audio patterns stored on a computer readable medium which may be accessed through computer instructions embodying the present invention. The geographic location may be used to determine a particular pattern meaningful to a particular location. For example, if the device is located near a beach, a different pattern may be used than that which may be appropriate for a city.

Further, speed/velocity of a device may affect playback speed of the pattern noted above. For example, a delay effect may be introduced if a device is moving more slowly compared to a predetermined or desired velocity. For example, the desired velocity may be set using a speed interface, or a change of speed/tempo may be selected through an interface as well.

Further, weather conditions may affect selection of a background loop. For example the number of notes played in a pattern may be increased in clear/sunny weather, decreased in inclement weather, etc.

Further, ambient temperature may affect a pitch of pattern notes in the audio stream.

Further, time of day may affect a number of notes played in a pattern. For example, a number of notes played in a pattern may be decreased during the evening, increased in daylight, increased in the evening based on location (nightclub, music venue, etc), decreased in daylight based on weather patterns, etc.

Furthermore, according to some example embodiments, a random element may be introduced to modify the mixing/audio pattern over time. Additionally, after a predetermined or desired time, the audio pattern may fade-out and after some time of background loop only, the pattern may fade back in as a variation depending upon the random element. This may be beneficial in that the audio pattern of the mixed audio stream is in constant variation thereby maintaining and/or increasing interest in the audio pattern.

The method 900 further includes producing the audio stream based on the determined audio properties at block 903. As described above, parameters may be retrieved periodically, based on any desired frequency, and thus audio properties may be adjusted over time as well. It follows that a new or altered audio stream may be produced constantly. For example, as a speed of a device changes, so may the tempo of the audio stream. Further, as weather changes, so may the tone of the audio stream.

Finally, the method 900 includes audio playback/visualization of the audio stream. The playback may be constant and may be dynamically adjusted based on retrieved parameters. The visualization may also be constant and may be dynamically adjusted based on the retrieved parameters. Further, as described above, the audio playback/visualization may be paused, rewound, moved forward, or ceased by a user through manipulation of an interface as described above.

FIG. 10 is an example system for real-time customization of an audio stream, according to an example embodiment. The system 1000 may include a server 1001. The server 1001 may include a plurality of information, including but not limited to, audio tracks, audio patterns, desirable notes/musical information (chords or other note patterns), computer executable code, or any other suitable information.

The system 1000 further includes a service provider 1003 in communication with the server 1001 over a network 1002. It is noted that although illustrated as separate, the service provider 1003 may include a server substantially similar to server 1001. The service provider may be a data service provider, for example, a cellular service provider, a weather information provider, a positioning service provider (satellite information, WiFi network position information, etc), or any other suitable provider. The service provider 1003 may also be an application server providing applications and/or computer executable code implementing any of the interfaces/methodologies described herein. The service provider 1003 may present a plurality of application defaults, choices, set-ups, and/or configurations such that a device may receive and process the application accordingly. The service provider 1003 may present any application on a user interface or web-browser of a device for relatively easy selection by a user of the device. The user interface or web-page rendered for application selection may be in the form of an application store and/or application marketplace.

The network 1002 may be any suitable network, including the Internet, wide area network, and/or a local network. The server 1001 and the service provider 1003 may be in communication with the network 1002 over communication channels 1010, 1011. The communication channels 1010, 1011 may be any suitable communication channels including wireless, satellite, wired, or otherwise.

The system 1000 further includes computer apparatus 1005 in communication with the network 1002, over communication channel 1012. The computer apparatus 1005 may be any suitable computer apparatus including a personal computer (fixed location), a laptop or portable computer, a personal digital assistant, a cellular telephone, a portable tablet computer, a portable audio player, or otherwise. For example, the system 1000 may include computer apparatuses 1004 and 1006, which are embodied as portable music players and/or cellular telephones with portable music players or music playing capabilities thereon. The apparatuses 1004 and 1006 may include display means 1041, 1061, and/or buttons/controls 1042, 1062. The controls 1042, 1062 may operate independently or in combination with any of the controls noted above. For example, the controls 1042, 1062 may be controls directed to cellular operation or default music player operations.

Further, the apparatuses 1004, 1005, and 1006 may be in communication with each other over communication channels 1115, 1116 (for example, wired, wireless, Bluetooth channels, etc); and may further be in communication with the network 1002 over communication channels 1012, 1013, and 1014.

Therefore, the apparatuses 1004, 1005, and 1006 may all be in communication with one or both of the server 1001 and the service provider 1003, as well as each other. Each of the apparatuses may be in severable communication with the network 1002 and each other, such that the apparatuses 1004, 1005, and 1006 may be operated without constant communication with the network 1002 (e.g., using data connection controls of an interface). For example, if there is no data availability or if a user directs an apparatus to work offline, the customized audio produced at any of the apparatuses 1004, 1005, and 1006 may be based on stored information/parameters. It follows that each of the apparatuses 1004, 1005, and 1006 may be configured to perform the methodologies described above; thereby producing real-time customized audio streams to a user of any of the apparatuses.

Furthermore, using any of the illustrated communication mediums, the apparatuses 1004, 1005, and 1006 may share, transmit, and/or receive different audio-streams previously or currently produced at any one of the illustrated elements of the system 1000. For example, a stored plurality of audio streams may be available on the server 1001 and/or the service provider 1003. Moreover, users of any other the devices 1004, 1005, and 1006 may transmit/share audio streams with other users. Additionally, a personalized bank of audio streams may be stored at the server 1001 and/or the service provider 1003.

As described above, features of example embodiments include listening to uniquely and/or real-time generated music/audio streams, sharing music moods with friends/users, mobile platform integration, and other unique features not found in the conventional art. For example, while typical generative music systems utilize fixed rules and algorithms of a pre-defined framework or database in order to create sound, audio generation of example embodiments is achieved through ongoing real-time transformation of online and offline data which trigger a subsequent sound creation process. Example embodiments use algorithmic routines as well to render the real-time data in such a manner that the musical result may sound meaningful.

Example embodiments may begin a new generative process upon initiation and continue to create sound until a request to terminate is received. Users can manually adjust values (i.e., mood, tempo, structure complexity, position) in order to manipulate the musical result according to their preferences and musical taste, in addition to manipulating any of the parameters described above. For example, a user may choose whether or not to include weather information or any other parameter to base the customized audio stream on.

Example embodiments may be configured to adjust/learn through explicit user feedback (e.g., ‘Do you like your audio stream?’ presented to a user for feedback on an interface) as well as through implicit user feedback (i.e., if audio stream generation applications are periodically set to a positive mood at a certain time of a day, output may be less melancholic because minor notes would be eliminated from the sound generation process, and vice versa).

Online data may also be regularly retrieved through the methods described herein, and may constantly influence the sound/melody generation, while offline data may be used to add specific characteristics and/or replace online data if a device is offline (e.g., through a severable connection).

Example embodiments may be configured to utilize different types of samples and sounds (i.e. by famous artists and musicians) offering the possibility to create a unique long-form application, each with a very characteristic and specific musical bias.

Additionally and as described above, example embodiments of the invention may be embodied in the form of computer-implemented processes and apparatuses for practicing those processes. Therefore, according to an example embodiment, the methodologies described hereinbefore may be implemented by a computer system or apparatus. A computer system or apparatus may be somewhat similar to the mobile devices and computer apparatuses described above, which may include elements as described below.

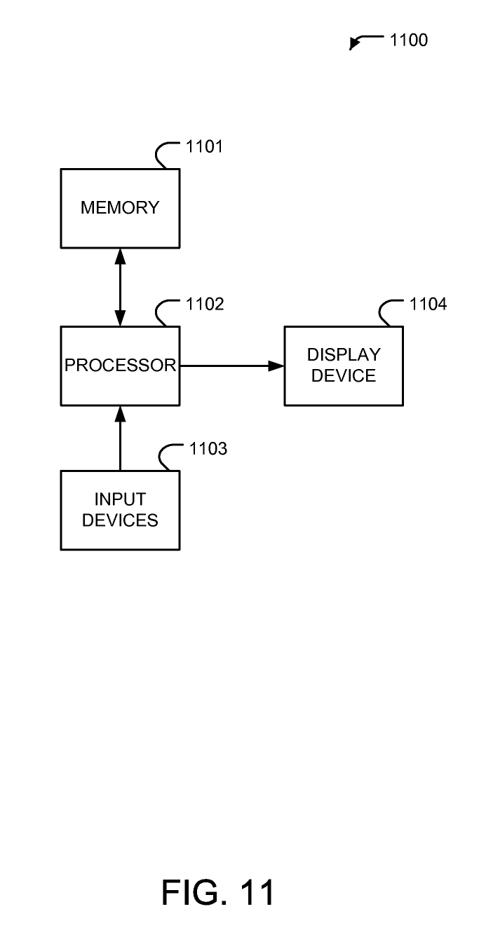

FIG. 11 illustrates a computer apparatus, according to an exemplary embodiment. Portions or the entirety of the methodologies described herein may be executed as instructions in a processor 1102 of the computer system 1100. The computer system 1100 includes memory 1101 for storage of instructions and information, input device(s) 1103 for computer communication, and display device 1104. Thus, the present invention may be implemented, in software, for example, as any suitable computer program on a computer system somewhat similar to computer system 1100. For example, a program in accordance with the present invention may be a computer program product causing a computer to execute the example methods described herein.

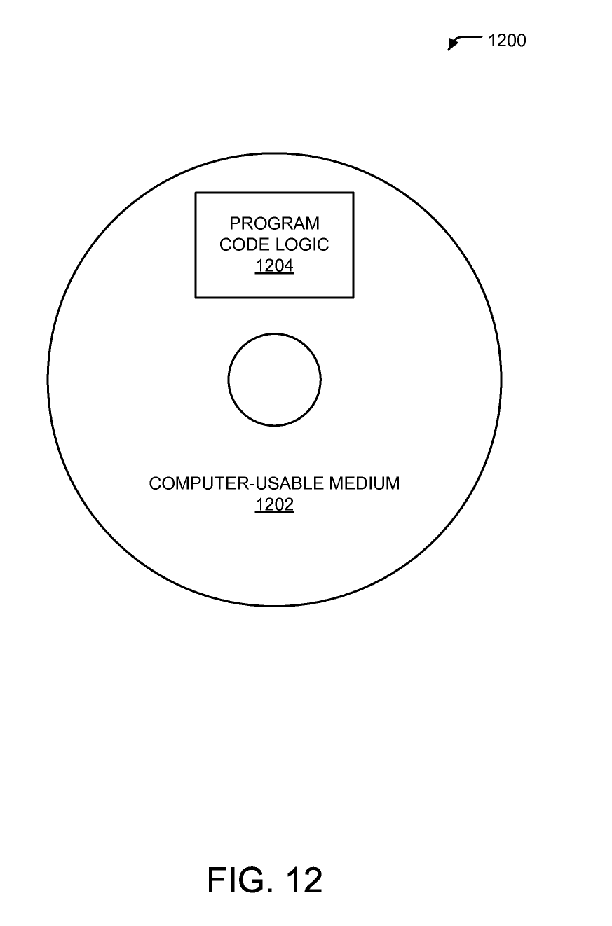

Therefore, embodiments can be embodied in the form of computer-implemented processes and apparatuses for practicing those processes on a computer program product. Embodiments include the computer program product 1200 as depicted in FIG. 12 on a computer usable medium 1202 with computer program code logic 1204 containing instructions embodied in tangible media as an article of manufacture. Exemplary articles of manufacture for computer usable medium 1202 may include floppy diskettes, CD-ROMs, hard drives, universal serial bus (USB) flash drives, or any other computer-readable storage medium, wherein, when the computer program code logic 1204 is loaded into and executed by a computer, the computer becomes an apparatus for practicing the invention. Embodiments include computer program code logic 1204, for example, whether stored in a storage medium, loaded into and/or executed by a computer, or transmitted over some transmission medium, such as over electrical wiring or cabling, through fiber optics, or via electromagnetic radiation, wherein, when the computer program code logic 1204 is loaded into and executed by a computer, the computer becomes an apparatus for practicing the invention. When implemented on a general-purpose microprocessor, the computer program code logic 1204 segments configure the microprocessor to create specific logic circuits.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

It should be emphasized that the above-described embodiments of the present invention, particularly, any detailed discussion of particular examples, are merely possible examples of implementations, and are set forth for a clear understanding of the principles of the invention. Many variations and modifications may be made to the above-described embodiment(s) of the invention without departing from the spirit and scope of the invention. All such modifications and variations are intended to be included herein within the scope of this disclosure and the present invention and protected by the following claims.

1. A method of real-time customization of an audio stream, comprising:
retrieving a set of parameters related to a current state of a device;
determining a pattern, tempo, background loop, pitch, and number of foreground notes for the audio stream based upon the set of parameters; and
creating an audio stream based upon the determination.

2. The method of claim 1, further comprising:
playing back the audio stream on the device.

3. The method of claim 1, further comprising updating the set of parameters based upon a predetermined frequency.

4. The method of claim 1, further comprising retrieving a set of pre-configured parameters if the current state of the device is not accessible.

5. The method of claim 1, wherein the current state of the device is the device's current geographical location, relative velocity, surrounding ambient temperature, and/or surrounding weather conditions.

6. The method of claim 1, further comprising intelligently adjusting the pattern determination based upon user interaction on the device over time.

7. A system of real-time customization of an audio stream, comprising:
a service provider, the service provider storing a plurality of information related to a state of a geographic location; and
a device in communication with the service provider, the device configured and disposed to retrieve information related to a state of the device from the service provider based on a geographic location of the device, and the device further configured and disposed to customize an audio-stream based on the retrieved information.

8. The system of claim 7, wherein the state of the device is the device's surrounding ambient temperature and/or surrounding weather conditions.

9. The system of claim 7, further comprising a server in communication with the device, the server storing a plurality of audio information.

10. The system of claim 9, wherein the device is configured and disposed to retrieve a portion of the audio information and customize the audio-stream through use of the retrieved portion.

11. The system of claim 7, wherein the service provider is a weather information provider, a cellular service provider, a data connection provider, or an application provider.

12. The system of claim 7, wherein the device is a portable music playing device, a portable computing device, a personal digital assistant, or a cellular telephone.

13. The system of claim 7, further comprising a plurality of devices in communication with the service provider and the device, wherein each of the plurality of devices is configured and disposed to share audio information between each of the plurality of devices.

14. The system of claim 7, wherein the device includes a display configured to render and display a visual graphic based on the customized audio stream.

15. A computer-implemented user-interface rendered on a display portion of a portable computer apparatus, the interface comprising:
a plurality of controls, each control of the plurality of controls including user-configurable and pre-existing states of the portable computer apparatus; wherein a processor of the portable computer apparatus is configured and disposed to perform a method of real-time customization of an audio stream, the method comprising:
retrieving a set of parameters based on user-manipulation of the user-interface and the plurality of controls;
determining a pattern, tempo, background loop, pitch, and number of foreground notes for a customized audio stream based upon the set of parameters; and
creating an audio stream based upon the determination.

16. A computer program product including a computer readable medium containing computer executable code thereon, wherein the computer executable code, when processed by a processor of a computer, directs the processor to perform a method of real-time customization of an audio stream, the method comprising:
retrieving a set of parameters related to a current state of a device;
determining a pattern, tempo, background loop, pitch, and number of foreground notes for the audio stream based upon the set of parameters; and
creating an audio stream based upon the determination.
